(19) United States
(12) Patent Application Publication
(10) Pub. No.: US 2015/0316703 A1
(43) Pub. Date: Nov. 5, 2015

(54) DUAL EDGE COUPLER

(71) Applicant: Cree, Inc., Durham, NC (US)

(72) Inventors: Jean-Claude David Ramey de Sugny, Santa Barbara, CA (US); Eric J. Tarsa, Goleta, CA (US)

(21) Appl. No.: 14/801,476

(22) Filed: Jul. 16, 2015

Related U.S. Application Data
(63) Continuation-in-part of application No. 14/577,730, filed on Dec. 19, 2014.
Application No. 14/577,730 is a continuation-in-part of application No. 14/472,078, filed on Aug. 28, 2014.
Application No. 14/472,078 is a continuation-in-part of application No. 62/020,666, filed on Jul. 3, 2014.
Application No. 62/020,666 is a continuation-in-part of application No. 13/842,521, filed on Mar. 15, 2013.
Application No. 13/842,521 is a continuation-in-part of application No. 13/839,949, filed on Mar. 15, 2013.
Application No. 13/839,949 is a continuation-in-part of application No. 13/841,074, filed on Mar. 15, 2013.
Application No. 13/841,074 is a continuation-in-part of application No. 13/841,622, filed on Mar. 15, 2013.
Application No. 13/841,622 is a continuation-in-part of application No. 13/840,563, filed on Mar. 15, 2013.
Application No. 13/840,563 is a continuation-in-part of application No. 13/938,877, filed on Jul. 10, 2013.
Application No. 13/938,877 is a continuation-in-part of application No. 14/015,801, filed on Aug. 30, 2013.
Application No. 14/015,801 is a continuation-in-part of application No. 14/101,086, filed on Dec. 9, 2013.
Application No. 14/101,086 is a continuation-in-part of application No. 14/101,132, filed on Dec. 9, 2013.
Application No. 14/101,132 is a continuation-in-part of application No. 14/101,147, filed on Dec. 9, 2013.
Application No. 14/101,147 is a continuation-in-part of application No. 14/101,129, filed on Dec. 9, 2013.
Application No. 14/101,129 is a continuation-in-part of application No. 14/101,051, filed on Dec. 9, 2013.
Application No. 14/101,051 is a continuation-in-part of application No. PCT/US14/13937, filed on Jan. 30, 2014.
Application No. PCT/US14/13937 is a continuation-in-part of application No. PCT/US14/13931, filed on Jan. 30, 2014.
Application No. PCT/US14/13931 is a continuation-in-part of application No. PCT/US14/30017, filed on Mar. 15, 2014.
Application No. PCT/US14/30017 is a continuation-in-part of application No. 14/472,064, filed on Aug. 28, 2014.
Application No. 14/472,064 is a continuation-in-part of application No. 14/472,078, filed on Aug. 28, 2014.
Application No. 14/472,078 is a continuation-in-part of application No. 14/472,035, filed on Aug. 28, 2014.
(60) Provisional application No. 61/922,017, filed on Dec. 30, 2013.

(51) Int. Cl. F21V 8/00

(52) U.S. Cl. CPC G02B 6/0028; G02B 6/0078; G02B 6/009

(57) ABSTRACT

According to one aspect, a luminaire comprising a first waveguide having a first coupling surface, a second waveguide having a second coupling surface, and a coupling optic optically coupled to the first coupling surface and the second coupling surface and adapted to receive a light source. The coupling optic comprising a central coupling section, a first light distribution section, and a second light distribution section opposed to the first light distribution section, wherein each of the first and second light distribution sections includes a first surface having a curved portion and a planar portion both bounded by a second surface and a third surface. The curved portion is proximal to the central coupling section and the planar portion is distal to the central coupling section.

### CROSS REFERENCE TO RELATED APPLICATIONS

The present application comprises a continuation-in-part of U.S. patent application Ser. No. 14/577,730, filed Dec. 19, 2014, entitled “Optical Waveguide Bodies and Luminaires Utilizing Same”, which claims the benefit of U.S. Provisional Patent Application No. 61/922,017, filed Dec. 30, 2013, entitled “Optical Waveguide Bodies and Luminaires Utilizing Same” and additionally comprises a continuation-in-part of U.S. patent application Ser. No. 14/472,078, filed Aug. 28, 2014, entitled “Waveguide Having Unidirectional Illuminance”, which claims the benefit of U.S. Provisional Patent Application No. 62/020,866, filed Jul. 3, 2014, entitled “Luminaires Utilizing Edge Coupling” all owned by the assignee of the present application, and the disclosures of which are incorporated by reference herein.

The present application further comprises a continuation-in-part of U.S. patent application Ser. No. 13/842,521, filed Mar. 15, 2013, entitled “Optical Waveguides”, and further comprises a continuation-in-part of U.S. patent application Ser. No. 13/839,949, filed Mar. 15, 2013, entitled “Optical Waveguide and Lamp Including Same”, and further comprises a continuation-in-part of U.S. patent application Ser. No. 13/841,074, filed Mar. 15, 2013, entitled “Optical Waveguide Body”, and further comprises a continuation-in-part of U.S. application Ser. No. 13/841,622, filed Mar. 15, 2013, entitled “Shaped Optical Waveguide Bodies”, and further comprises a continuation-in-part of U.S. patent application Ser. No. 13/840,563, filed Mar. 15, 2013, entitled “Optical Waveguide and Luminaire Incorporating Same”, and further comprises a continuation-in-part of U.S. patent application Ser. No. 13/938,877, filed Jul. 10, 2013, entitled “Optical Waveguide and Luminaire Incorporating Same”, and further comprises a continuation-in-part of U.S. patent application Ser. No. 14/015,801, filed Aug. 30, 2013, entitled “Consolidated Troffer”, and further comprises a continuation-in-part of U.S. patent application Ser. No. 14/101,086, filed Dec. 9, 2013, entitled “Optical Waveguides and Luminaires Incorporating Same”, and further comprises a continuation-in-part of U.S. patent application Ser. No. 14/101,132, filed Dec. 9, 2013, entitled “Waveguide Bodies Including Redirection Features and Methods of Producing Same”, and further comprises a continuation-in-part of U.S. patent application Ser. No. 14/101,147, filed Dec. 9, 2013, entitled “Luminaires Using Waveguide Bodies and Optical Elements”, and further comprises a continuation-in-part of U.S. patent application Ser. No. 14/101,129, filed Dec. 9, 2013, entitled “Simplified Low Profile Module With Light Guide For Pendant, Surface Mount, Wall Mount and Stand Alone Luminaires”, and further comprises a continuation-in-part of U.S. patent application Ser. No. 14/101,051, filed Dec. 9, 2013, entitled “Optical Waveguide and Lamp Including Same”, and further comprises a continuation-in-part of International Application No. PCT/US14/13937, filed Jan. 30, 2014, entitled “Optical Waveguide Bodies and Luminaires Utilizing Same”, and further comprises a continuation-in-part of International Application No. PCT/US14/13931, filed Jan. 30, 2014, entitled “Optical Waveguides and Luminaires Incorporating Same”, and further comprises a continuation-in-part of International Application No. PCT/US14/30017, filed Mar. 15, 2014, entitled “Optical Waveguide Body, and further comprises a continuation-in-part of U.S. patent application Ser. No. 14/472,064 entitled “Luminaire with Selectable Luminous Intensity Pattern”, filed Aug. 28, 2014, and further comprises a continuation-in-part of U.S. patent application Ser. No. 14/472,078 entitled “Waveguide Having Unidirectional Illuminance”, filed Aug. 28, 2014, and further comprises a continuation-in-part of U.S. patent application Ser. No. 14/472,035 entitled “Luminaires Utilizing Edge Coupling”, filed Aug. 28, 2014, all owned by the assignee of the present application, and the disclosures of which are incorporated by reference herein.

### REFERENCE REGARDING FEDERALLY SPONSORED RESEARCH OR DEVELOPMENT

Not applicable

### SEQUENTIAL LISTING

Not applicable

### FIELD OF DISCLOSURE

The present subject matter relates to lighting devices, and more particularly, to a luminaire incorporating waveguides for general illumination.

### BACKGROUND

An optical waveguide mixes and directs light emitted by one or more light sources, such as one or more light emitting diodes (LEDs). A typical optical waveguide includes three main components: one or more coupling surfaces or elements, one or more distribution elements, and one or more extraction elements. The coupling component(s) direct light into the distribution element(s), and condition the light to interact with the subsequent components. The one or more distribution elements control how light flows through the waveguide and such control is dependent on the waveguide geometry and material. The extraction element(s) determine how light is removed by controlling where and in what direction the light exits the waveguide.

When designing a coupling element, the primary considerations are: maximizing the efficiency of light transfer from the source into the waveguide; controlling the location of light injected into the waveguide; and controlling the angular distribution of the light in the waveguide. The coupling element of a waveguide may be comprised of one or more of a number of optical elements, including a primary source optic (such as the lens on an LED component package), one or more intermediate optical elements (such as a lens or array of lenses) interposed between the source(s) and the waveguide coupling surface or surfaces, one or more reflective or scattering surfaces surrounding the sources, and specific optical geometries formed in the waveguide coupling surfaces themselves. Proper design of the elements that comprise the coupling element can provide control over the spatial and angular spread of light within the waveguide (and thus how the light interacts with the extraction elements), maximize the coupling efficiency of light into the waveguide, and improve the mixing of light from various sources within the waveguide (which is particularly important when the color from the sources varies—either by design or due to normal bin-to-bin variation in lighting components). The elements of the waveguide coupling system can use refraction, reflection, total internal reflection, and surface or volume scattering to control the distribution of light injected into the waveguide.

It is desirable to maximize the number of light rays emitted by the source(s) that impinge directly upon the coupling surface in order to increase the coupling of light from a light source into a waveguide. Light rays that are not directly incident on the waveguide from the source must undergo one or more reflections or scattering events prior to reaching the waveguide coupling surface. Each such ray is subject to absorption at each reflection or scattering event, leading to light loss and inefficiencies. Further, each ray that is incident on the coupling surface has a portion that is reflected (Fresnel reflection) and a portion that is transmitted into the waveguide. The percentage that is reflected is smallest when the ray strikes the coupling surface at an angle of incidence relative to the surface normal close to zero (i.e., approximately normal to the surface). The percentage that is reflected is largest when the ray is incident at a large angle relative to the surface normal of the coupling surface (i.e., approximately parallel to the surface).

In one type of coupling, a light source that emits a Lambertian distribution of light is positioned adjacent to the edge of a planar waveguide element. The amount of light that directly strikes the coupling surface of the waveguide in this case is limited due to the wide angular distribution of the source and the relatively small solid angle represented by the adjacent planar surface. To increase the amount of light that directly strikes the coupling surface, a flat package component such as the Cree ML-series or MK-series (manufactured and sold by Cree, Inc. of Durham, N.C., the assignee of the present application) may be used. A flat package component is a light source that does not include a primary optic or lens formed about an LED chip. A flat emitting surface of the flat package component may be placed in close proximity to the coupling surface of the waveguide. While this arrangement helps ensure a large portion of the emitted light is directly incident on the waveguide, overall system efficiency generally suffers as flat package components are typically less efficient than components having primary lenses, which facilitate light extraction from the LEDs, improving overall efficiency.

After light has been coupled into the waveguide, it must be guided and conditioned to the locations of extraction. The simplest example is a fiber-optic cable, which is designed to transport light from one end of the cable to another with minimal loss in between. To achieve this, fiber optic cables are only gradually curved and sharp bends in the waveguide are avoided. In accordance with well-known principles of total internal reflection light traveling through a waveguide is reflected back into the waveguide from an outer surface thereof, provided that the incident light strikes the outer surface at an angle relative to a surface normal greater than the critical angle.

In order for an extraction element to remove light from the waveguide, the light must first contact the feature comprising the element. By appropriately shaping the waveguide surfaces, one can control the flow of light across the extraction feature(s) and thus influence both the position from which light is emitted and the angular distribution of the emitted light. Specifically, the design of the coupling and distribution surfaces, in combination with the spacing (distribution), shape, and other characteristic(s) of the extraction features provide control over the appearance of the waveguide (luminance), its resulting light distribution (illuminance), and system optical efficiency.

Low-profile LED-based luminaires for general lighting applications have recently been developed (e.g., General Electric's ET series panel troffers) that utilize a string of LED components directed into the edge of a waveguiding element (an “edge-lit” approach). However, such luminaires typically suffer from low efficiency due to losses inherent in coupling light emitted from a predominantly Lambertian emitting source such as a LED component into the narrow edge of a waveguide plane.

### SUMMARY

According to one aspect, a coupling optic includes a central coupling section, a first light distribution section, and a second light distribution section opposed to the first light distribution section. Each of the first and second light distribution sections includes a first surface having a curved portion and a planar portion both bounded by a second surface and a third surface, wherein the curved portion is proximal to the central coupling section and the planar portion is distal to the central coupling section.

According to another aspect, a luminaire includes a first waveguide having a first coupling surface and a second waveguide having a second coupling surface. A coupling optic is optically coupled to the first coupling surface and the second coupling surface and adapted to receive a light source. The coupling optic comprising a central coupling section, a first light distribution section, and a second light distribution section opposed to the first light distribution section, wherein each of the first and second light distribution sections includes a first surface having a curved portion and a planar portion both bounded by a second surface and a third surface, such that the curved portion is proximal to the central coupling section and the planar portion is distal to the central coupling section.

According to another aspect, a luminaire includes a first waveguide having a first coupling surface, a second waveguide having a second coupling surface. A coupling optic is coupled to the first coupling surface and the second coupling surface and is adapted to receive a light source. The coupling optic comprises a central coupling section including a central cavity defined by a substantially conical coupling surface disposed adjacent to a substantially cylindrical coupling surface, a first light distribution section, and a second light distribution section opposed to the first light distribution section.

According to another aspect, a coupling optic including a central coupling section having a central cavity defined by a substantially conical coupling surface disposed adjacent to a substantially cylindrical coupling surface, a first light distribution section, and a second light distribution section opposed to the first light distribution section.

Other aspects and advantages will become apparent upon consideration of the following detailed description and the attached drawings wherein like numerals designate like structures throughout the specification.

### BRIEF DESCRIPTION OF THE DRAWINGS

FIG. 1 is an isometric, exploded view of an embodiment of a coupling optic and first and second waveguides;

FIG. 2 is an enlarged exploded fragmentary cross-sectional view of the coupling optic and the waveguides of FIG. 1 taken generally along lines 2-2 of FIG. 1;

FIG. 3 is an isometric view of a coupling optic of FIG. 1;

FIG. 4 is a plan view of the coupling optic of the embodiment of the luminaire of FIG. 1;

FIG. 5 is an enlarged fragmentary cross-sectional view of the central coupling section shown in FIG. 3 taken generally along line 5-5 of FIG. 3;

FIG. 6 is an enlarged fragmentary cross-sectional ray trace diagram;

FIG. 7 is an isometric view of a luminaire incorporating the coupling element and waveguides of FIG. 1;

FIG. 8 is an enlarged fragmentary sectional view taken generally along lines 8-8 of FIG. 7; and

FIG. 9 is an enlarged sectional view taken generally along lines 9-9 of FIG. 7.

### DETAILED DESCRIPTION

As shown in the FIGS., embodiments of a luminaire of the present application utilize edge coupling to couple light from a light source into one or more waveguides. Such waveguides receive light developed by light sources that are disposed between the waveguides. One or more coupling optics are disposed between the waveguides and minimize the incidence of reflections and/or scattering events, which would otherwise lead to losses and a reduction in coupling efficiency. In the drawings, like reference numerals connote like structures throughout. The following examples further illustrate specific embodiments but, of course, should not be construed in any way as limiting the scope of this disclosure.

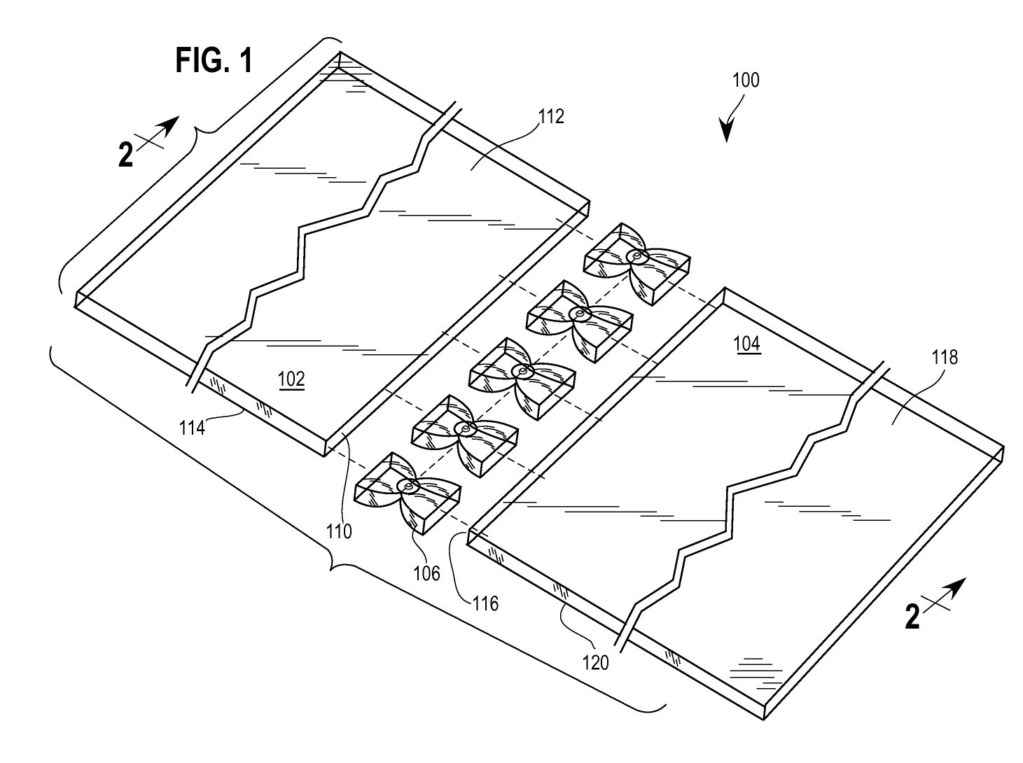

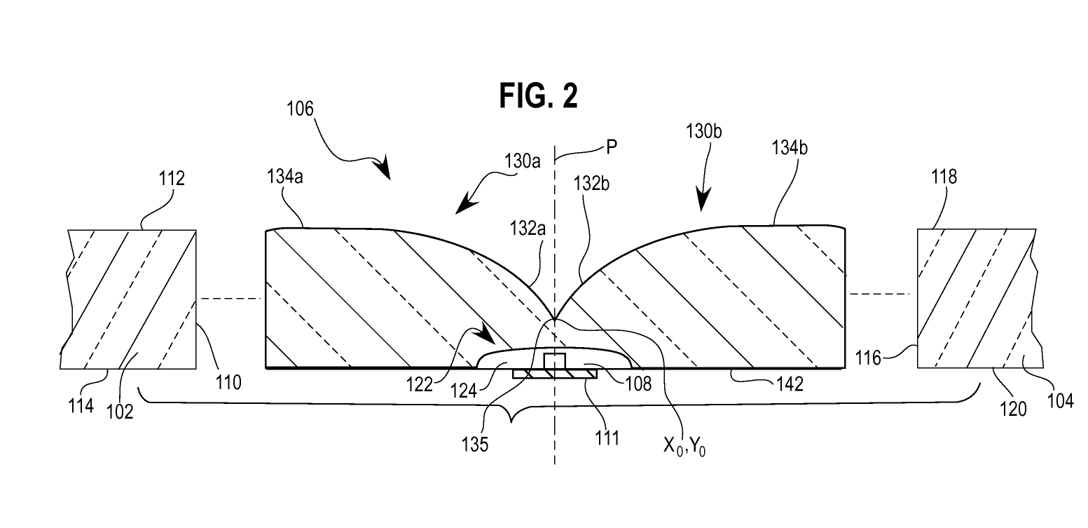

FIG. 1, illustrates one or more coupling optics 106 disposed between a first waveguide 102 and a second waveguide 104. Referring also to FIG. 2, each coupling optic 106 directs light rays emanating from an associated light source, preferably in the form of one or more LEDs 108, into each of the first and second waveguides 102, 104. The first waveguide 102 has a first coupling surface 110 extending between first opposing surfaces 112, 114, and the second waveguide 104 has a second coupling surface 116 extending between second opposing surfaces 118, 120. Light rays are coupled through the first and second coupling surfaces 110 and 116 into the respective first and second waveguides 102 and 104. In other embodiments, the coupling optic 106 may be used with a single waveguide or with more than two waveguides as desired.

Referring specifically to FIG. 2, each coupling optic 106 includes a central coupling section 122 that forms a central cavity 124, also referred to as an optical cavity. The LEDs 108 are disposed inside the cavity 124 although other suitable light emitting elements may be utilized. In some embodiments a primary optic such as a lens (not shown) may be placed over one or more LEDs 108 such that the lens completely surrounds the LEDs. The lens modifies the distribution of light developed by the LEDs as necessary or desirable. In some embodiments the cavity 124 surrounding the LED 108 may be filled with an optical adhesive (not shown). Light from the LEDs 108 is directed by the coupling optic 106 and coupled to the first and second coupling surfaces 110, 116 of the first and second waveguides 102, 104 respectively. The coupling optic 106 may use specular or diffuse reflection, refraction, scattering, total internal reflection (TIR) or any combination of methods for redirecting the light into the first and second coupling surfaces 110, 116.

Each LED 108 element or module may be a single white or other color LED, or each may comprise multiple LEDs either mounted separately or together on a single substrate or package to form a module including, for example, at least one phosphor-coated LED either alone or in combination with at least one color LED, such as a green LED, a yellow LED, a red LED, etc. In those cases where a soft white illumination is to be produced, each LED 108 element or module or a plurality of such elements or modules may include one or more blue shifted yellow LEDs and one or more red LEDs. The LEDs may be disposed in different configurations and/or layouts as desired. Different color temperatures and appearances could be produced using other LED combinations, as is known in the art. The luminaire may include LEDs 108 of the same type of phosphor-converted white LED, or any combination of the same or different types of LEDs discussed herein. In some embodiments, a luminaire may include a plurality of groups of LEDs 108, where each group may include LEDs 108 having different colors and/or color temperatures. The groups of LEDs 108 may be separated by dividers (not shown), as described below, wherein the LEDs 108 are disposed within the coupling cavity. In embodiments having LEDs of the same or similar color, dividers may not be necessary or desired. Further, in one embodiment, the light source may comprise any LED, for example, an MT-G LED incorporating TrueWhite® LED technology or as disclosed in U.S. patent application Ser. No. 13/649,067, filed Oct. 10, 2012, entitled “LED Package with Multiple Element Light Source and Encapsulant Having Planar Surfaces” by Lowes et al., (Cree Docket No. P1912US1-7), the disclosure of which is hereby incorporated by reference herein, as developed and manufactured by Cree, Inc., the assignee of the present application. If desirable, a side emitting LED disclosed in U.S. Pat. No. 8,541,795, the disclosure of which is incorporated by reference herein, may be utilized inside the waveguide body. In some embodiments, each LED 108 element or module may comprise one or more LEDs disposed vertically within the coupling cavity. In any of the embodiments disclosed herein the LED 108 element(s) or module(s) may have a Lambertian or near-Lambertian light distribution, although preferably each may have a directional emission distribution (e.g., a side emitting distribution), as necessary or desirable to further increase the portion of light directly incident on the first and second coupling surfaces 110, 116, or to modify or control the angular distribution of light within the waveguide. More generally, any Lambertian, near-Lambertian, symmetric, wide angle, preferential-sided, or asymmetric beam pattern LED(s) may be used as the light source.

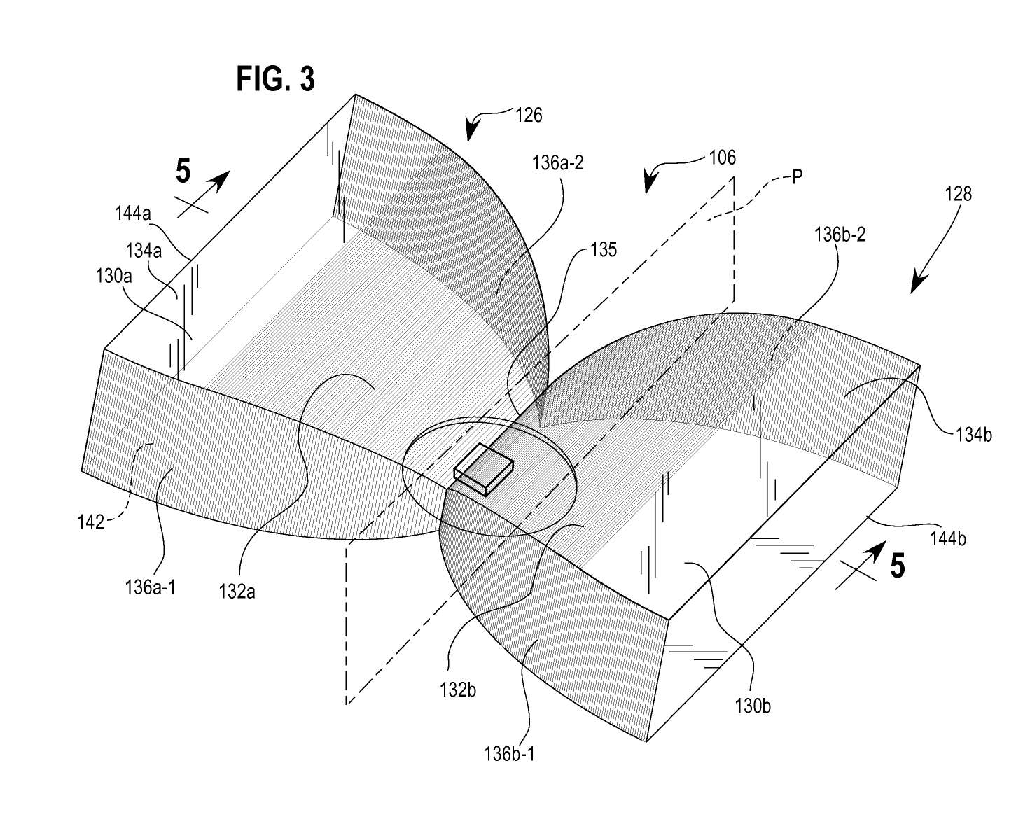

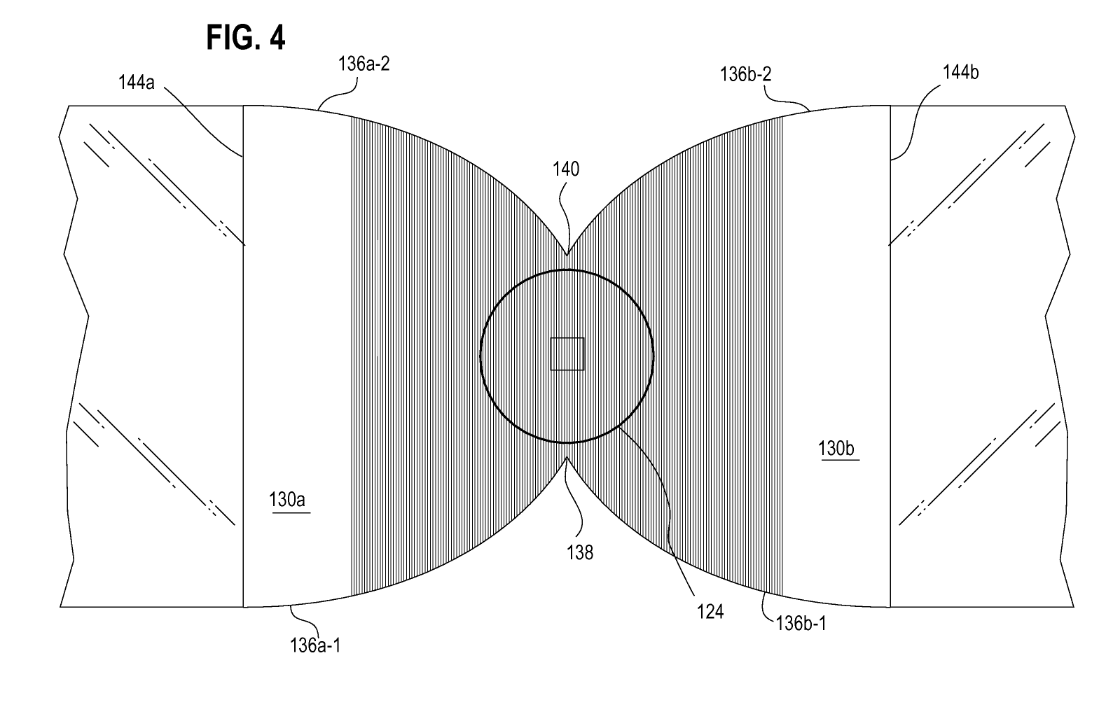

Referring to FIGS. 2-4, the coupling optic 106 preferably comprises a single integrated element and includes a first light distribution section 126 opposed to a second light distribution section 128. The opposing light distribution sections 126, 128 are identical in the sense that the two are symmetric with respect to one another about an imaginary plane P (FIGS. 2 and 3). Therefore, like features of the first and second light distribution sections 126, 128 are referred to by like reference numerals having different suffixes. Each of the first and second light distribution sections 126, 128, includes a first surface 130a and 130b respectively. Each first surface 130a and 130b has an associated curved portion 132a and 132b and a planar portion 134a and 134b. Each of the curved portions 132a, 132b is proximal to the central coupling section 122 while the planar portions 134a, 134b are distal from the central coupling section 122. Moreover, the first surfaces 130a, 130b of the respective light distribution sections 126, 128 converge at line 135 spaced from the cavity 124 as shown in FIGS. 2 and 3. In some embodiments, such location may be offset relative to a central axis of the LED 108 or other point. The transition between the curved portions 132a, 132b and the planar portions 134a, 134b, respectively, may be smooth, without any discontinuities, or may include abrupt slope changes. Each of the first surfaces 130a, 130b is bounded by associated and adjacent second surfaces 136a-1, 136b-1 and third surfaces 136a-2 136b-2, respectively, that are transverse to, and more particularly, perpendicular to the first surfaces 130a, 130b, respectively. In the illustrated embodiment, the second and third surfaces 136a-1, 136b-1, 136a-2, 136b-2 are curved. As shown in FIG. 4, the second surfaces 136a-1, 136b-1 converge at a first side location 138 laterally outside of the cavity 124. Similarly, the third surfaces 136a-2, 136b-2 converge at a second side location 140 laterally outside the cavity 124 opposite the first side location 138. A fourth surface 142 opposite to the first surfaces 130a, 130b, may be substantially or completely planar.

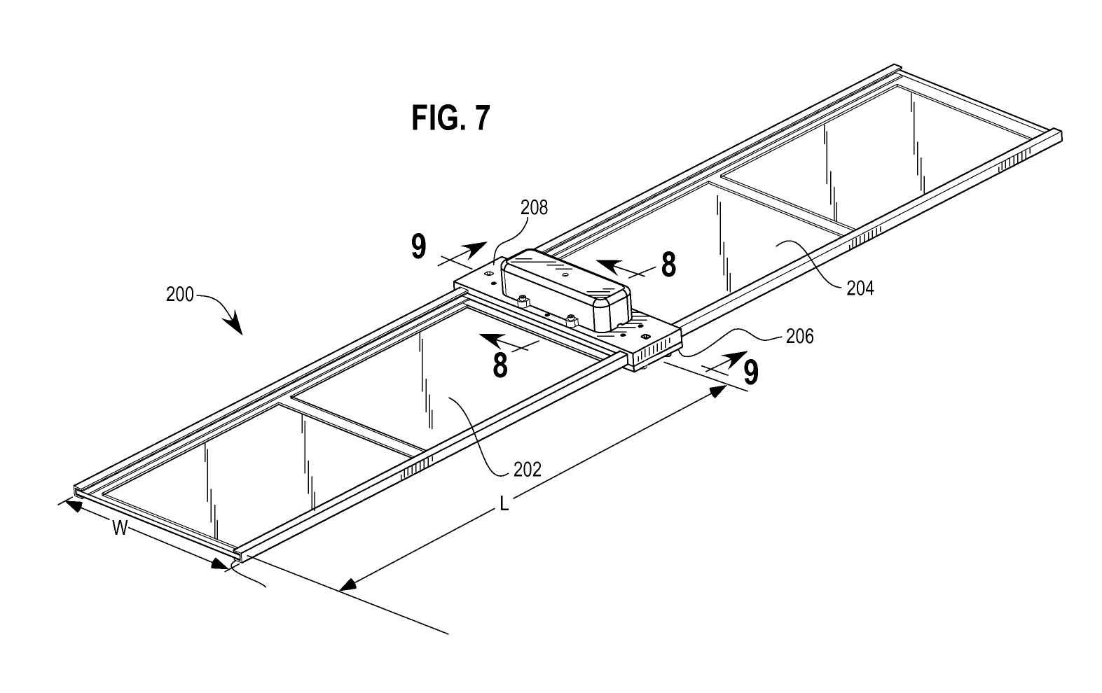

Light transmitted into the first and second light distribution sections 126, 128 totally internally reflects off of the surfaces 130a, 130b, 136a-1, 136b-1, 136a-2, 136b-2 and eventually exits output surfaces 144a and 144b as shown in FIG. 6. In one embodiment, the coupling optic 106 may be adapted to collimate light rays at angles suitable for transmission into the first and second waveguides 102, 104. The curvatures of the first surface curved portions 132a, 132b, the second surfaces 136a-1, 136b-1 and the third surfaces 136a-2, 136b-2 may be elliptical, parabolic, faceted, planar surfaces approximating a curve, or the like.

In some embodiments, the surfaces 130a, 130b, 136a-1, 136b-1, 136a-2, 136b-2 may be designed to redirect incident light through total internal reflection (TIR). Specifically, the curvature of the surfaces 130a, 130b, 136a-1, 136b-1, 136a-2, and 136b-2 may be determined by iteratively plotting the points using a differential or quasi-differential equation. One iterative process includes, for each surface 130a, 130b, 136a-1, 136b-1, 136a-2, 136b-2, the steps of locating a start point at coordinates xₒ, yₒ, in a plane that contains the cross-sectional profile of the surface, wherein the y direction is in the normal direction to the output surfaces 144a and 144b, and the x direction is then perpendicular to the y direction in such plane. The xₒ and yₒ coordinates are chosen to provide sufficient separation between the central coupling section 122 and the line 135 and between the coupling section 122 and the first and second side locations 138 and 140, respectively, for acceptable mechanical rigidity. Thus, for example as seen in FIG. 2, the xₒ and yₒ coordinates are chosen as a starting point in a plane that contains the cross-sectional profile of the surface 130a. Then the xₒ and yₒ coordinates are used to calculate the slope necessary at that location to totally internally reflect light rays emanating at various angles from the central coupling section 122, and, based on the calculated slope, further calculating the necessary incremental radial step Δy that corresponds to a predetermined incremental lateral change Δx, moving to a new point x+Δx and y+Δy, and repeating the calculation and moving steps until the calculated slope is parallel to the y axis. In this manner the desired curvatures for surfaces 130a and 130b are achieved that provide for total internal reflection of light rays emanating from the central coupling section 122. The determined points define the curvature of the surface 130a, which does not change with cross-sectional plane.

Similarly, this process is repeated for the surfaces 130b, 136a-1, 136b-1, 136a-2 and 136b-2 to generate the profiles of each surface. As with the surface 130a, the profiles of these surfaces do not change with cross-section. It should be noted that since x,y coordinates are chosen as the convention to define the profiles of surfaces 130a and 130b, then z,y coordinates are used to define the profiles of the surfaces 136a-1, 136b-1, 136a-2 and 136b-2. Also, in the event that some surfaces require longer lengths to achieve the end condition than others, the shorter surfaces are extended in the y direction such that all lengths match. For example, as shown in FIGS. 3 and 4, the surfaces 136a-1, 136b-1, 136a-2 and 136b-2 are continuously curved and extend from the central coupling section 122 to the respective surfaces 144a and 144b. On the other hand, as shown in FIGS. 2 and 6, curved portions 132a and 132b of surfaces 130a and 130b are shorter surfaces and only partially extend the distance from the central coupling section 122 toward the surfaces 144a and 144b. The shorter curved surfaces 132a and 132b are extended through the planar surfaces 134a and 134b in the y direction such that the total lengths of surfaces 130a and 130b match with the total lengths of surfaces 136a-1, 136b-1, 136a-2 and 136b-2.

In other embodiments, the shape of the surfaces 130a, 130b, 136a-1, 136b-1, 136a-2, 136b-2 may be designed using geometric and/or differential equations possibly in combination with other curved, planar, or piecewise linear surfaces. For example, equations described in U.S. patent application Ser. No. 14/472,078, filed Aug. 28, 2014, entitled “Waveguide having Unidirectional Illuminance” incorporated by reference herein, may be used to define the surfaces 130a, 130b, 136a-1, 136b-1, 136a-2 and 136b-2.

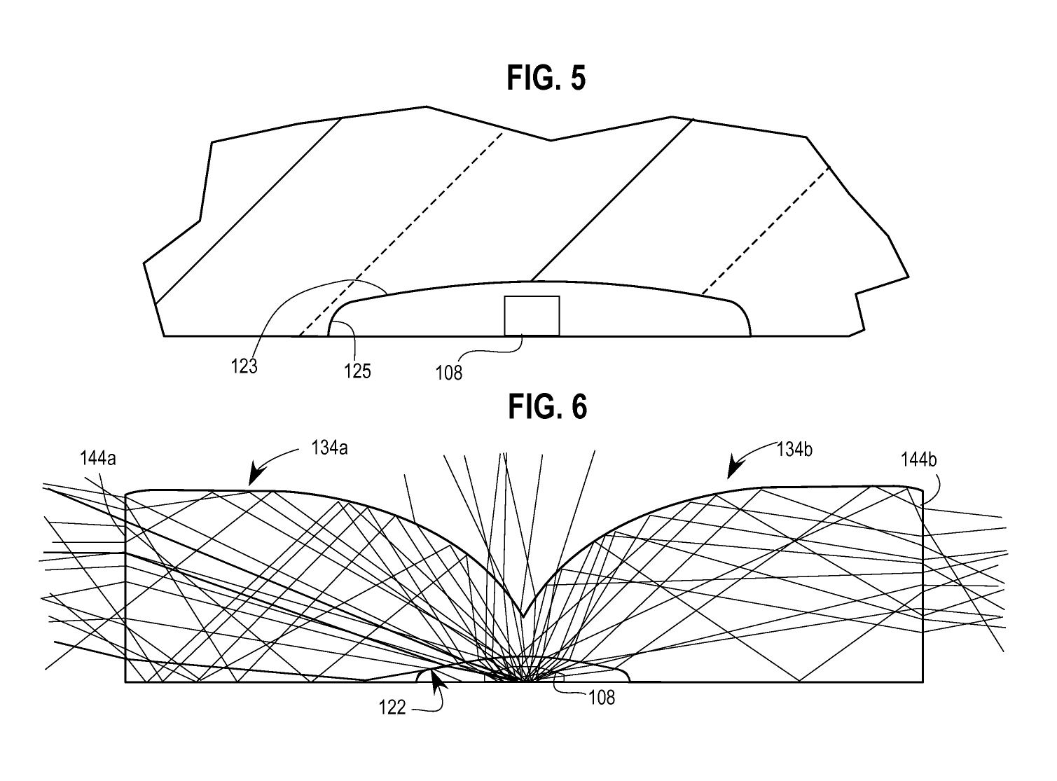

Referring to FIG. 5, the shape of the central coupling section 122 is defined by a substantially conical coupling surface 123 that is disposed adjacent to a substantially cylindrical coupling surface 125. Alternatively, any other suitable surface shapes could be employed. The shape and geometry of the central coupling section 122 may depend in part on the shape of curvatures of the first surface 130a, 130b, the second surfaces 136a-1, 136b-1, and the third surfaces 136a-2, 136b-2, and vice versa. In other words, the shape and/or size of the central coupling section 122 is dependent upon the shapes and/or sizes of the curved and planar surfaces 130a, 130b, 136a-1, 136a-2, 136b-1,136b-2 and vice versa for a given light output distribution from the coupling optic 106.

Referring to FIG. 6, light rays emanating from the LED 108 are incident upon the central coupling section 122 whereupon they are refracted as they enter the first and second light distribution sections 126 and 128. The lights rays are then totally internally reflected and directed outward from the exit surfaces 144a and 144b.

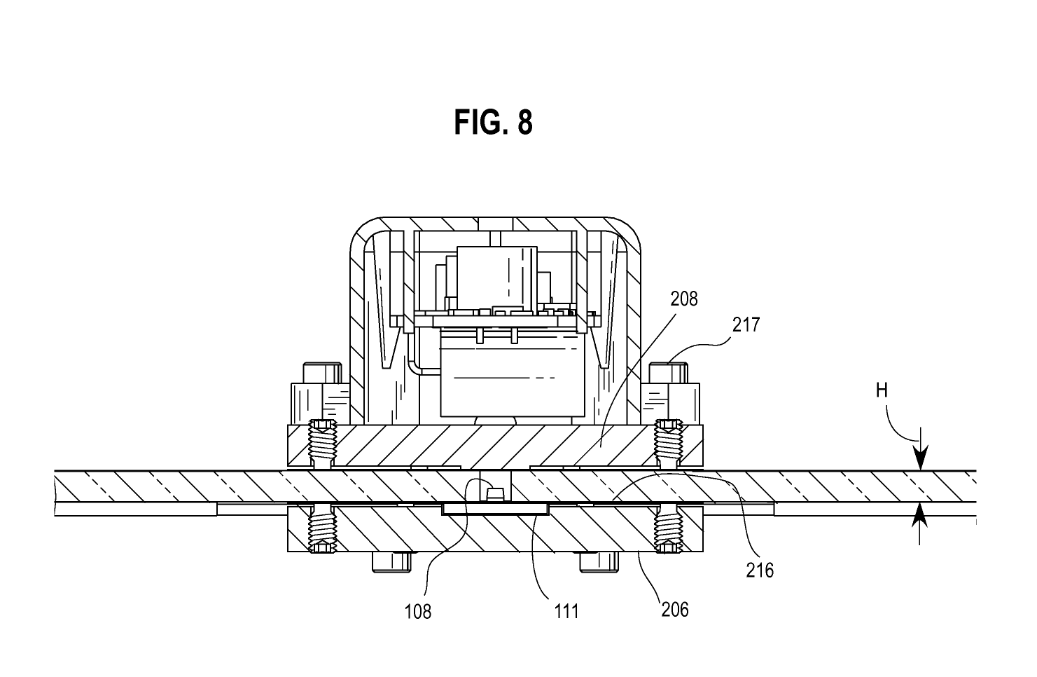

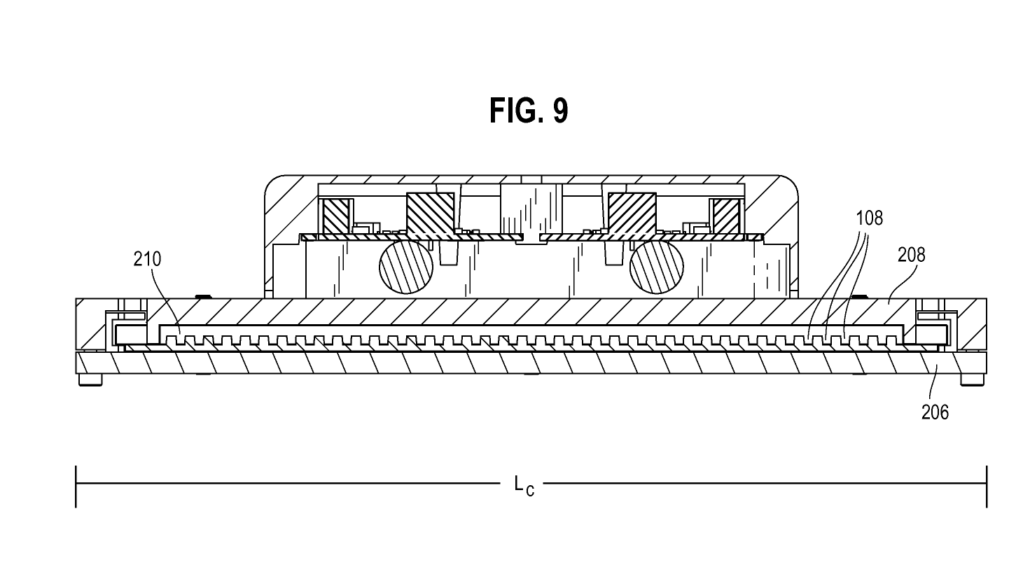

FIGS. 7-9 illustrate a luminaire 200 that utilizes a dual edge coupling methodology. Referring to FIGS. 7-9, a first waveguide 202 and a second waveguide 204 are disposed between opposing first and second structural members 206, 208 and are spaced apart to provide a space or channel 210 for accommodating the one or more coupling optics 106 best seen in FIG. 9. As seen in FIGS. 8 and 9, a plurality of LEDs 108 is disposed on a printed circuit board 111 mounted on an inner surface 216 of the first structural member 206. The second structural member 208 is disposed opposite the first structural member 206 and is joined thereto by fasteners 217. Each waveguide has a length L (FIG. 7), a width W (FIG. 7), and a height H (FIG. 8). In the illustrated embodiment, the first and second waveguides 102, 104 are identical, although this need not be the case. In other embodiments, a luminaire may include a greater or lesser number of identical or non-identical waveguides having the same or different sizes and/or shapes. Further, as shown in FIG. 9 the channel 210 has a length Lc corresponding to the width of the waveguide 102, 104 along which the plurality of LEDs 108 is disposed.

Each LED 108 extending from the inner surface 216 of the first member 206 adjacent the first and second coupling surfaces 110, 116 produces a near-Lambertian light distribution where some but not all of the light rays are directly incident on the first and second coupling surfaces 110, 116 of the waveguides 102, 104. The coupling optic 106 directs light not directly incident on the adjacent coupling surfaces 110, 116 onto the coupling surfaces 110, 116 with a minimum number of reflections.

In the embodiment shown in FIG. 9, the coupling optics 106 are disposed along the widths of the first and second waveguides 102 and 104. Although the coupling optics 106 are shown as being separated in the exploded view of FIG. 1, they are preferably disposed side-by-side in an abutting arrangement in some embodiments. In other embodiments, the coupling optics 106 may be spaced apart by a predetermined distance. In yet other embodiments, the coupling optics 106 may be separated by interstitial elements disposed between them. The coupling optic 106 may be acrylic, a reflective polymer, or a substantially transparent member with reflective, scattering, refractive, and/or TIR surfaces, and may include a reflective or scattering coating or the like. The reflective coating may be a white opaque material. Also, the first surfaces 130a, 130b, second surfaces 136a-1, 136b-1, and third surfaces 136a-2 and 136b-2 may be specular reflective surfaces. Still further, the material(s) of the waveguides 102, 104 and the coupling optics 106 preferably comprise optical grade materials that exhibit TIR characteristics including, but not limited to, one or more of acrylic, air, polycarbonate, molded silicone, glass, and/or cyclic olefin copolymers, and combinations thereof, possibly in a layered arrangement, to achieve a desired effect and/or appearance. Preferably, although not necessarily, the waveguides 102, 104 and the coupling optic 106 are all solid or some or all have one or more voids or discrete bodies of differing materials therein. The coupling optic 106 could be made from any optically clear material with suitable mechanical durability and formable into the desired shapes. The aforementioned listing of materials are not exhaustive and are a representative sampling of materials with appropriate properties. The waveguides 102, 104 may be fabricated using procedures such as hot embossing or molding, including injection/compression molding. Other manufacturing methods may be used as desired.

Any of the embodiments disclosed herein may include a power circuit having a buck regulator, a boost regulator, a buck-boost regulator, a SEPIC power supply, or the like, and may comprise a driver circuit as disclosed in U.S. patent application Ser. No. 14/291,829, filed May 30, 2014, entitled “High Efficiency Driver Circuit with Fast Response” by Hu et al. (Cree docket no. P2276US1, attorney docket no. 034643-000618) or U.S. patent application Ser. No. 14/292,001, filed May 30, 2014, entitled “SEPIC Driver Circuit with Low Input Current Ripple” by Hu et al. (Cree docket no. P2291US1, attorney docket no. 034643-000616) incorporated by reference herein. The circuit may further be used with light control circuitry that controls color temperature of any of the embodiments disclosed herein in accordance with viewer input such as disclosed in U.S. patent application Ser. No. 14/292,286, filed May 30, 2014, entitled “Lighting Fixture Providing Variable CCT” by Pope et al. (Cree docket no. P2301US1) incorporated by reference herein.

Further, any of the embodiments disclosed herein may be used in a luminaire having one or more communication components forming a part of the light control circuitry, such as an RF antenna that senses RF energy. The communication components may be included, for example, to allow the luminaire to communicate with other luminaires and/or with an external wireless controller, such as disclosed in U.S. patent application Ser. No. 13/782,040, filed Mar. 1, 2013, entitled “Lighting Fixture for Distributed Control” or U.S. Provisional Application No. 61/932,058, filed Jan. 27, 2014, entitled “Enhanced Network Lighting” both owned by the assignee of the present application and the disclosures of which are incorporated by reference herein. More generally, the control circuitry includes at least one of a network component, an RF component, a control component, and a sensor. The sensor, such as a knob-shaped sensor, may provide an indication of ambient lighting levels thereto and/or occupancy within the room or illuminated area. Such sensor may be integrated into the light control circuitry.

### INDUSTRIAL APPLICABILITY

At least some of the luminaires disclosed herein are particularly adapted for use in installations, such as, indoor products (e.g., downlights, troffers, a lay-in or drop-in application, a surface mount application onto a wall or ceiling, etc.) preferably requiring a total luminaire output of at least about 100 lumens or greater, and, in some embodiments, a total luminaire output of at least about 3,000 lumens, and in other embodiments, a total lumen output of about 10,000 lumens to about 20,000 lumens. Further, the luminaires disclosed herein preferably have a color temperature of between about 2500 degrees Kelvin and about 6200 degrees Kelvin, and, in some embodiments, between about 2500 degrees Kelvin and about 5000 degrees Kelvin, and, in other embodiments, about 2700 or 3500 degrees Kelvin. Also, at least some of the luminaires disclosed herein preferably exhibit an efficacy of at least about 80 lumens per watt, more preferably at least about 100, and most preferably 120 lumens per watt (generally, higher efficacies are achievable at higher color temperatures). Additionally, at least some of the luminaires disclosed herein preferably exhibit an overall efficiency (i.e., light extracted out of the waveguide divided by light injected into the waveguide) of at least about 70 percent, preferably, at least about 80 percent, and most preferably, at least about 90 percent. A color rendering index (CRI) of at least about 80 is preferably attained by at least some of the luminaires disclosed herein, with a CRI of at least about 88 being more preferable, and at least about 90 being most preferable. Some luminaires exhibit a CRI of at least about 90 while maintaining a relatively high efficiency. Any desired particular output light distribution, such as a butterfly light distribution, could be achieved, including up and down light distributions or up only or down only distributions, etc.

When one uses a relatively small light source which emits into a broad (e.g., Lambertian) angular distribution (common for LED-based light sources), the conservation of etendue, as generally understood in the art, requires an optical system having a large emission area to achieve a narrow (collimated) angular light distribution. In the case of parabolic reflectors, a large optic is thus generally required to achieve high levels of collimation. In order to achieve a large emission area in a more compact design, the prior art has relied on the use of Fresnel lenses, which utilize refractive optical surfaces to direct and collimate the light. Fresnel lenses, however, are generally planar in nature, and are therefore not well suited to re-directing high-angle light emitted by the source, leading to a loss in optical efficiency. In contrast, in the present invention, light is coupled into the optic, where primarily TIR is used for re-direction and collimation. This coupling allows the full range of angular emission from the source, including high-angle light, to be re-directed and collimated, resulting in higher optical efficiency in a more compact form factor.

As in the present embodiments, a waveguide may include various combinations of mixing features, extraction features, and redirection features necessary to produce a desired light distribution. A lighting system may be designed without constraint due to color mixing requirements, the need for uniformity of color and brightness, and other limits that might otherwise result from the use of a specific light source. Further, the light transport aspect of a waveguide allows for the use of various form factors, sizes, materials, and other design choices. The design options for a lighting system utilizing a waveguide as described herein are not limited to any specific application and/or a specific light source.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

We claim:

1. A coupling optic, comprising:
a central coupling section;
a first light distribution section; and
a second light distribution section opposed to the first light distribution section,
wherein each of the first and second light distribution sections includes a first surface having a curved portion and a planar portion both bounded by a second surface and a third surface, wherein the curved portion is proximal to the central coupling section and the planar portion is distal from the central coupling section.

2. The coupling optic of claim 1, wherein the curved portion and the planar portion form a continuous surface.

3. The coupling optic of claim 2, wherein the first surface is disposed transverse to the second surface and the third surface.

4. The coupling optic of claim 3, wherein the first and second light distribution sections are adapted to enable light emitted from a light source to totally internally reflect within the first and second light distribution sections into a first waveguide and a second waveguide respectively.

5. The coupling optic of claim 4, wherein curvatures of the first surface curved portion and the second surface and the third surface are determined by iteratively plotting points using a differential equation.

6. The coupling optic of claim 5, wherein the curved portions of the first surface of each of the first and second light distribution sections converge at a location spaced apart from the central cavity, and wherein the second surface and the third surface of each of the first and second light distribution sections converge at locations laterally outside of the central cavity.

7. The coupling optic of claim 5, wherein the central coupling section includes coupling surfaces defining a central cavity for receiving a light source, and wherein the coupling surfaces comprise a substantially conical central surface disposed adjacent to a substantially cylindrical outer surface.

8. A luminaire, comprising:
a first waveguide having a first coupling surface;
a second waveguide having a second coupling surface;
a coupling optic disposed adjacent to the first coupling surface and the second coupling surface and adapted to receive a light source, the coupling optic comprising:
a central coupling section;
a first light distribution section; and
a second light distribution section opposed to the first light distribution section,
wherein each of the first and second light distribution sections includes a first surface having a curved portion and a planar portion both bounded by a second surface and a third surface, and wherein the curved portion is proximal to the central coupling section and the planar portion is distal from the central coupling section.

9. The luminaire of claim 8, wherein the curved portion and the planar portion form a continuous surface.

10. The luminaire of claim 9, wherein the first surface is disposed transverse to the second surface and the third surface.

11. The luminaire of claim 8, in combination with a light source disposed in the central coupling section.

12. The luminaire of claim 11, wherein the first and second light distribution sections are adapted to enable light emitted from the light source to totally internally reflect within the respective first and second light distribution sections into the respective first and second waveguides.

13. The luminaire of claim 12, wherein the coupling optic is adapted to collimate light rays at angles suitable for transmission into the first and second waveguides.

14. The luminaire of claim 12, wherein curvatures of the first surface curved portion and the second surface and the third surface are determined by iteratively plotting points using a differential equation.

15. The luminaire of claim 14, wherein the curved portions of the first surface of each of the first and second light distribution sections converge at a location spaced apart from the central cavity, and wherein the second surface and the third surface of each of the first and second light distribution sections converge at locations laterally outside of the central cavity.

16. A luminaire, comprising:
a first waveguide having a first coupling surface;
a second waveguide having a second coupling surface;
a coupling optic disposed adjacent to the first coupling surface and the second coupling surface and adapted to receive a light source, the coupling optic comprising:
a central coupling section including a central cavity defined by a substantially conical coupling surface disposed adjacent to a substantially cylindrical coupling surface;
a first light distribution section; and
a second light distribution section opposed to the first light distribution section.

17. The luminaire of claim 16, wherein the first and second light distribution sections are adapted to enable light emitted from the light source to totally internally reflect within the respective first and second light distribution sections into the respective first and second waveguides.

18. The luminaire of claim 17, wherein each of the first and second light distribution sections includes a first surface having a curved portion and a planar portion both bounded by a second surface and a third surface, wherein the curved portion is proximal to the central coupling section and the planar portion is distal from the central coupling section.

19. The luminaire of claim 18, wherein curvatures of the first surface curved portion and the second surface and the third surface are determined by iteratively plotting points using a differential equation

20. The luminaire of claim 18, wherein the curved portions of the first surface of each of the first and second light distribution sections converge at a location spaced apart from the central cavity, and wherein the second surface and the third surface of each of the first and second light distribution sections converge at locations laterally outside of the central cavity.
